(19) United States
(12) Patent Application Publication
(10) Pub. No.: US 2014/0103576 A1
(43) Pub. Date: Apr. 17, 2014

(54) PLASTIC INJECTION MOLDING DEVICE AND METHOD USING THE SAME

(71) Applicant: QUANTA COMPUTER INC., Taoyuan Shien (TW)

(72) Inventors: Chien-Chiang HUANG, Taoyuan County (TW); Tsung-Chin LIU, New Taipei City (TW)

(73) Assignee: QUANTA COMPUTER INC., Taoyuan Shien (TW)

(21) Appl. No.: 13/846,369

(22) Filed: Mar. 18, 2013

(30) Foreign Application Priority Data
Oct. 11, 2012 (TW) 101137498

(51) Int. Cl. B29C 45/40

(52) U.S. Cl. CPC B29C 45/4005; B29C 45/40
USPC 264/319; 425/556

(57) ABSTRACT

A plastic injection molding device and a method using the same are provided. The plastic injection molding device is formed with a female mold and a male mold. The male mold is formed with a plastic passing portion and a partition portion. The plastic passing portion is formed in a Y shape including two linear passages in communication with each other. The partition portion is disposed between the two linear passages. After a liquid plastic material is fully filled in a cavity jointly formed by the male and the female mold, a whole plastic body is integrally solidified in both of the cavity and the plastic passing portion. When the whole plastic body is discharged from the cavity, the plastic body in the plastic passing portion is snapped by the partition portion.

### RELATED APPLICATIONS

This application claims priority to Taiwan application no. 101137498, filed, Oct. 11, 2012, the entirety of which is incorporated herein by reference.

### BACKGROUND

1. Technical Field

The present disclosure relates to a molding device, and more particularly to a plastic injection molding device.

2. Description of Related Art

In a conventional method of injection molding for producing a plastic product, plastic passing locations are typically arranged on lateral sides of an exterior of a plastic product. However, such an arrangement has a number of disadvantages. First, after the plastic product is formed, it is necessary to perform post-production operations with respect to the exterior of the plastic product (e.g., utilizing a cutting tool to remove any residual plastic material). As a result, the average cost of post-production and the rejection rate associated with post-production are increased. Second, if it is desired to omit the operation of utilizing a cutting tool for removing residual plastic material after the finished product is formed, another operation of tapering an angle pin on a male mold or female mold for mating with the whole mold has to be performed. However, in order to taper an angle pin on a male mold or female mold, the whole mold has to be modified, and thus, the cost of producing the whole mold and the rejection rate generated during the production process will be increased, and moreover, limitations are placed on the design of the mold.

Therefore, the conventional method of injection molding is associated with inconvenience and drawbacks which require improvement. This is especially the case after a plastic material undergoes injection molding processing, in which CNC machining of a milling material tip or tapering angle pin on a male mold or a female mold for mating with the whole mold is required for eliminating plastic passing location marks. Thus, there is a need to effectively solve the above-mentioned inconvenience and drawbacks.

### SUMMARY

One aspect of the present disclosure is to provide a plastic injection molding device and a method using the same, in which most of the residual plastic material on a finished plastic product can be split during a mold separating process, thereby reducing the possible postproduction requirements (e.g., utilizing a cutting tool for removing residual plastic material) or the requirement associated with tapering an angle pin on a male mold or female mold for mating with the whole mold.

The present disclosure provides a plastic injection molding device and a method using the same, in which plastic passing locations are arranged on an inner side opposite to an exterior of a finished plastic product, such that the design of a tapering angle pin or a slide member on a mold is unneeded.

One technical solution provided by the present disclosure is to disclose a plastic injection molding device, according to one embodiment thereof, the plastic injection molding device includes a female mold and a male mold. The female mold is formed with a plastic injecting passage. The male mold is formed with a plastic passing portion and a partition portion. The plastic passing portion is formed with a first linear passage and a second linear passage which are in communication with each other. The second linear passage is obliquely connected with the first linear passage. The partition portion is disposed between the first linear passage and the second linear passage. The partition portion is formed in a wedge shape and formed with a breaking edge for splitting the part of the plastic body in the first linear passage and the part of the plastic body in the second linear passage.

When the male mold and the female mold are engaged with each other, a cavity is defined between the female mold and the male mold, the first linear passage is in communication with the cavity, and the second linear passage is in communication with the plastic injecting passage.

After a liquid plastic material is filled into the cavity from the plastic injecting passage, the liquid plastic material is integrally solidified in the plastic injecting passage, the plastic passing portion and the cavity so as to form a whole plastic body.

When the male mold is separated from the female mold, and the plastic body is pushed and discharged from the male mold, the partition portion is served to split the part of the plastic body in the first linear passage and the part of the plastic body in the second linear passage.

According to this embodiment, the plastic injection molding device further includes an ejection device. The ejection device includes a first ejection post and a second ejection post. The first ejection post is disposed on a mating surface of the male mold which faces the female mold, and corresponding to the location of the cavity. The second ejection post is disposed on the mating surface of the male mold which faces the female mold, and corresponding to the location of the plastic injecting passage. The partition portion is disposed between the first ejection post and the second ejection post. When the male mold and the female mold are separated from each other, the first ejection post and the second ejection post are used for respectively ejecting the part of the plastic body in the first linear passage and the part of the plastic body in the second linear passage from the mating surface of the male mold which faces the female mold.

As one alternative of this embodiment, the plastic passing portion is formed in a Y shape, and the second linear passage is obliquely connected between two opposite ends of the first linear passage. One end of the first linear passage is exposed on the mating surface of the male mold which faces the female mold, and a buffer zone is formed between the other end of the first linear passage and the second linear passage.

As one alternative of this embodiment, the plastic passing portion is formed in a V shape, one end of the first linear passage is exposed on the mating surface of the male mold which faces the female mold, and the other end of the first linear passage is in direct communication with the second linear passage.

As one alternative of this embodiment, the male mold is further formed with a buffer concave slot. The buffer concave slot is formed on the mating surface of the male mold which faces the female mold, and is in communication with the second linear passage. An opening size of the buffer concave slot is larger than an opening size of the second linear passage. When the male mold and the female mold are engaged, the buffer concave slot is in communication with the plastic injecting passage.

Another technical solution provided by the present disclosure is to disclose a method of plastic injection molding using the above-mentioned plastic injection molding device and including the steps of engaging the male mold and the female mold; filling a liquid plastic material from the plastic injecting passage, so the liquid plastic material is enabled to be integrally solidified in the plastic injecting passage, the plastic passing portion and the cavity forming a whole plastic body; separating the male mold from the female mold; and ejecting the plastic body from the male mold thereby causing the part of the plastic body between the first linear passage and the second linear passage to be snapped by the partition portion.

Substantially, the first ejection post and the second ejection post are used for respectively ejecting the part of the plastic body in the first linear passage and the part of the plastic body in the second linear passage from the mating surface of the male mold which faces the female mold. The part of the plastic body between the first linear passage and the second linear passage is snapped by the breaking edge of the partition portion.

With the disclosed plastic injection molding device and the method using the same, the residual plastic material on a finished plastic product can be split during the mold separating process, such that CNC machining of a milling material tip or a tapering angle pin on a male mold or female mold is unneeded. Hence, the average cost of post-production and the rejection rate generated during post-production can be reduced.

### BRIEF DESCRIPTION OF THE DRAWINGS

The present disclosure will be apparent to those skilled in the art by reading the following detailed description of a preferred embodiment thereof, with reference to the attached drawings, in which:

FIG. 1 is a schematic view illustrating a plastic injection molding device in a mold opening state according to one embodiment of the present disclosure;

FIG. 2 is a schematic view illustrating the plastic injection molding device shown in FIG. 1 in a mold engaging state according to one embodiment of the present disclosure;

FIG. 3A is an enlarged view of area M of FIG. 1;

FIG. 3B is an enlarged view of area M of FIG. 1 according to another embodiment of the present disclosure;

FIG. 4 is a flow chart illustrating a method using a plastic injection molding device according to one embodiment of the present disclosure;

FIG. 5 is a schematic view illustrating step (402) of FIG. 4;

FIG. 6 is a schematic view illustrating step (403) of FIG. 4;

FIG. 7 is a schematic view illustrating step (404) of FIG. 4; and

FIG. 8 is a schematic view illustrating step (405) of FIG. 4.

### DESCRIPTION OF THE EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

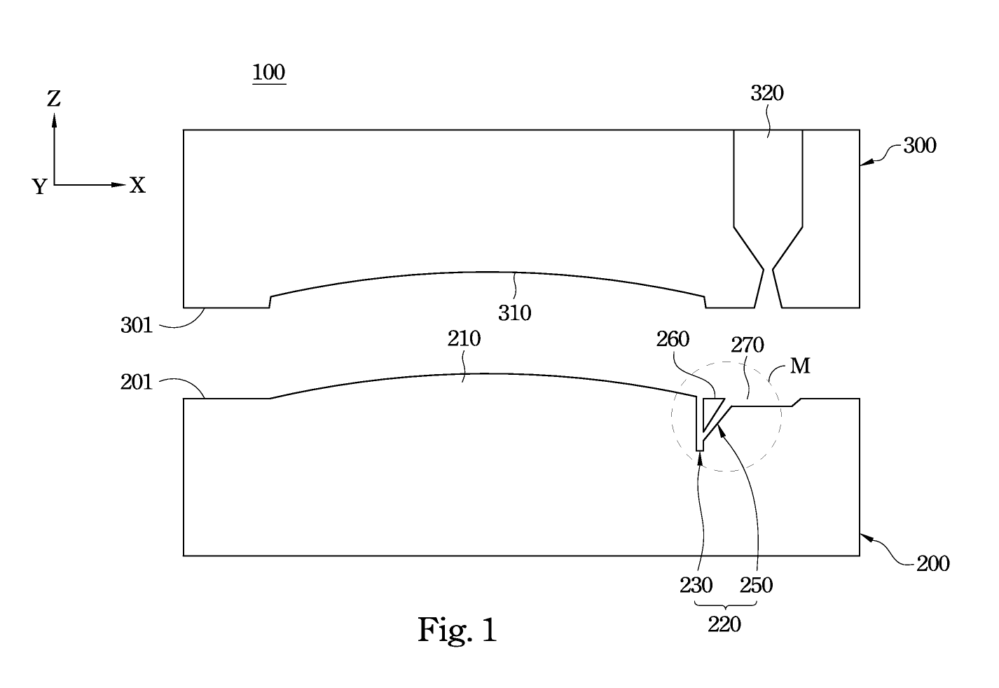

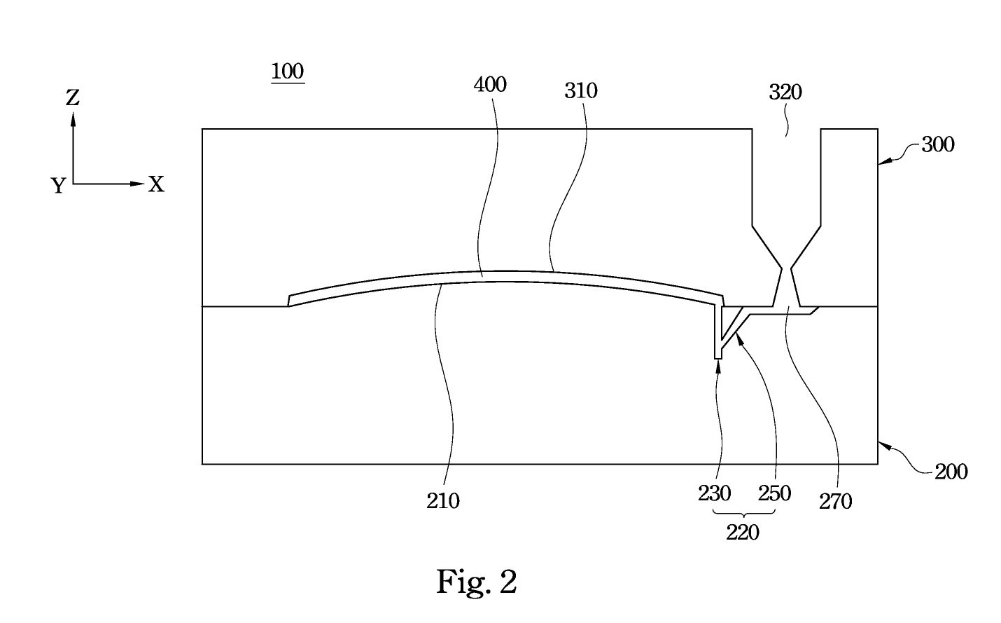

Reference is now made to FIG. 1 and FIG. 2. FIG. 1 is a schematic view illustrating a plastic injection molding device 100 in a mold opening state according to one embodiment of the present disclosure and FIG. 2 is a schematic view illustrating the plastic injection molding device 100 shown in FIG. 1 in a mold engaging state according to one embodiment of the present disclosure.

The plastic injection molding device 100 includes a male mold 200 and a female mold 300. The male mold 200 and the female mold 300 can be engaged with each other along a Z-axis direction (i.e., engaged with each other to thereby be in a mold engaging state as shown in FIG. 2), so that a process of filling plastic material for formation can be performed. Also, the male mold 200 and the female mold 300 can be separated from each other along the Z-axis direction (i.e., separated from each other to thereby be in a mold opening state as shown in FIG. 1), so that a process of discharging a finished product can be performed.

The female mold 300 is formed with a recessed portion 310 and a plastic injecting passage 320. The recessed portion 310 is formed on a mating surface 301 of the female mold 300 and faces the male mold 200. The plastic injecting passage 320 is formed starting from a surface of the female mold 300 and extends to the mating surface 301 of the female mold 300 which faces the male mold 200, thereby allowing a high temperature and high pressure liquid plastic material, e.g., polyvinyl chloride (PVC) or acrylonitrile butadiene styrene (ABS), to be injected from the plastic injecting passage 320. The male mold 200 is formed with a protrusion portion 210, a plastic passing portion 220 and a partition portion 260. The protrusion portion 210 is disposed on a mating surface 201 of the male mold 200, faces the female mold 300, and corresponds in position to the recessed portion 310. The plastic passing portion 220 is formed with a first linear passage 230 and a second linear passage 250 which are in communication with each other. The second linear passage 250 is obliquely connected with the first linear passage 230, and the partition portion 260 is disposed between the first linear passage 230 and the second linear passage 250.

When the male mold 200 and the female mold 300 are engaged in the mold engaging state as shown in FIG. 2, a cavity 400 is defined by the recessed portion 310 of the female mold 300 and the protrusion portion 210 of the male mold 200. The cavity 400 is in communication with the first linear passage 230, and the second linear passage 250 is in communication with the plastic injecting passage 320, and thus, the plastic injecting passage 320 can be in communication with the cavity 400 through the plastic passing portion 220.

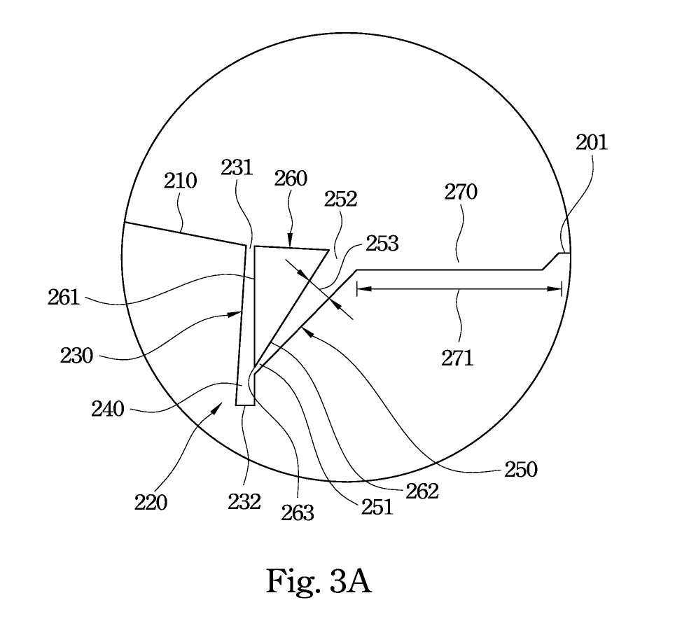

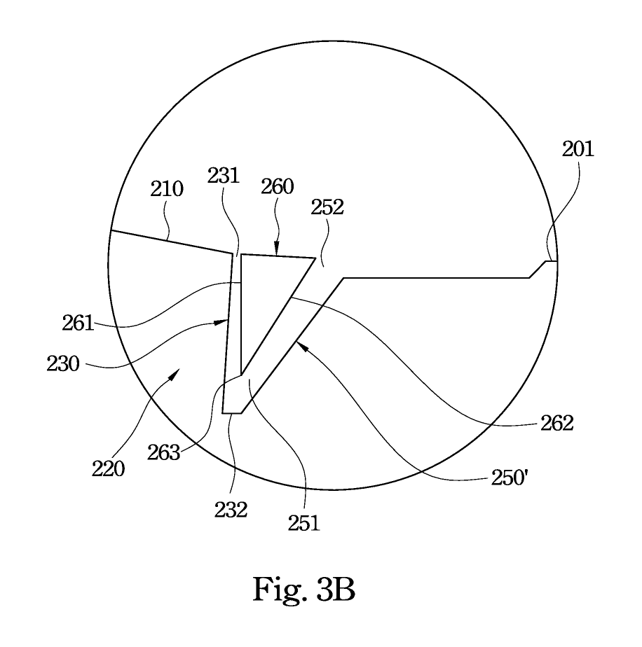

Reference is now made to FIG. 2 and FIG. 3A. FIG. 3A is an enlarged view of area M of FIG. 1.

The first linear passage 230 is formed with a first end 231 and a second end 232 opposite to the first end 231, the second linear passage 250 is formed with a third end 251 and a fourth end 252 opposite to the third end 251. The extending direction of the first linear passage 230 is the same as the moving direction of the female mold 300 (e.g., the Z-axis direction). The first end 231 of the first linear passage 230 is in communication with the cavity 400, i.e., is exposed on the mating surface 201 of the male mold 200 which faces the female mold 300. The second end 232 of the first linear passage 230 is separated a distance from the first end 231 of the first linear passage 230 along the Z-axis direction to thereby be separated from the female mold 300. The third end 251 of the second linear passage 250 is in communication with the first linear passage 230 between the first end 231 and the second end 232 of the first linear passage 230. The extending direction of the second linear passage 250 is not parallel with the Z-axis direction, so as to form an included angle with the Z-axis direction. Thus, the plastic passing portion 220 is formed in a Y shape due to the extending direction of the first linear passage 230 and the extending direction of the second linear passage 250. The fourth end 252 of the second linear passage 250 is in communication with the plastic injecting passage 320 of the female mold 300. That is, the fourth end 252 of the second linear passage 250 is exposed on the mating surface 201 of the male mold 200 which faces the female mold 300 in proximity to the plastic injecting passage 320 of the female mold 300 to thereby be in communication with the plastic injecting passage 320 of the female mold 300.

A buffer zone 240 is formed from the second end 232 of the first linear passage 230 to the second linear passage 250. Thus, liquid plastic material in the first linear passage 230 and flowing towards the cavity 400 can be buffered in the buffer zone 240, so as to reduce the flow speed and pressure of the liquid plastic material. Through such a configuration, the exterior of a finished plastic product is prevented from being formed with a mark caused by plastic passing stress. However, it is to be noted that the scope of the present disclosure is not limited to such a configuration.

Reference is now made to FIG. 1 and FIG. 3B. FIG. 3B is an enlarged view of area M of FIG. 1 according to another embodiment of the present disclosure. In this embodiment, the extending direction of the first linear passage 230 (e.g., the Z-axis direction) is the same as the moving direction of the female mold 300 (as shown in FIG. 1). The third end 251 of the second linear passage 250′ is in direct communication with the second end 232 of the first linear passage 230, so the plastic passing portion 220 is formed in a V shape due to the extending direction of the first linear passage 230 and that of the second linear passage 250′.

According to the disclosed embodiments and referring to FIG. 3A and FIG. 3B, the second linear passage 250, 250′ is obliquely connected with the first linear passage 230, so the partition portion 260 between the second linear passage 250, 250′ and the first linear passage 230 is formed in a wedge shape. A first surface 261 of the partition portion 260 is formed on an inner wall of the first linear passage 230, a second surface 262 of the partition portion 260 is formed angled from the first surface 261 and on an inner wall of the second linear passage 250, and the first surface 261 and the second surface 262 meet at ends thereof to thereby form a breaking edge 263 therebetween. (***, please mark the surfaces 261, 262 in FIG. 3B.)

In addition, referring to FIG. 1, in one embodiment, the male mold 200 is further formed with a buffer concave slot 270. The buffer concave slot 270 is formed on the mating surface 201 of the male mold 200 which faces the female mold 300, and when the male mold 200 and the female mold 300 are engaged in the mold engaging state as shown in FIG. 2, the buffer concave slot 270 is disposed between the second linear passage 250 and the plastic injecting passage 320, and in communication with the second linear passage 250 and the plastic injecting passage 320.

Referring again to FIG. 3A, it is noted that because an opening size 271 of the buffer concave slot 270 is larger than an opening size 253 of the second linear passage 250, the buffer concave slot 270 can buffer liquid plastic material flowing towards the second linear passage 250, and thereby prolong the time required by the liquid plastic material to enter the second linear passage 250. As a result, the flow speed and pressure of the liquid plastic material are reduced, such that the exterior of a finished plastic product is prevented from being formed with a mark caused by plastic passing stress. However, the present disclosure is not limited to such a configuration.

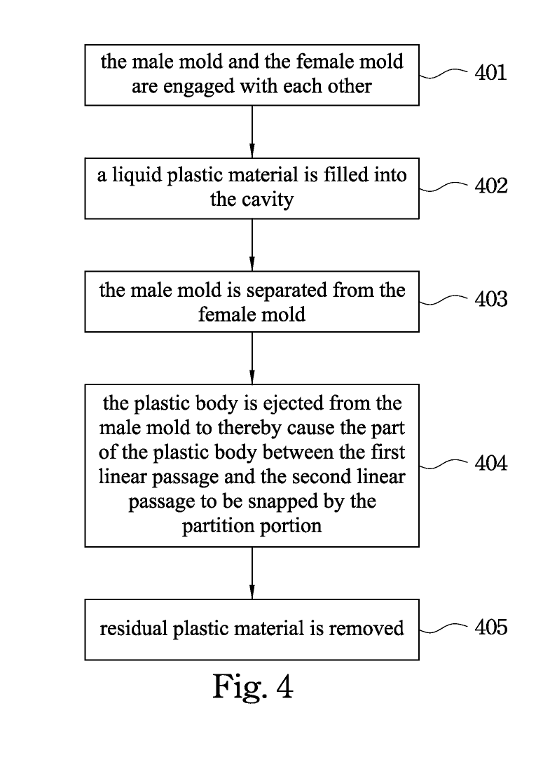

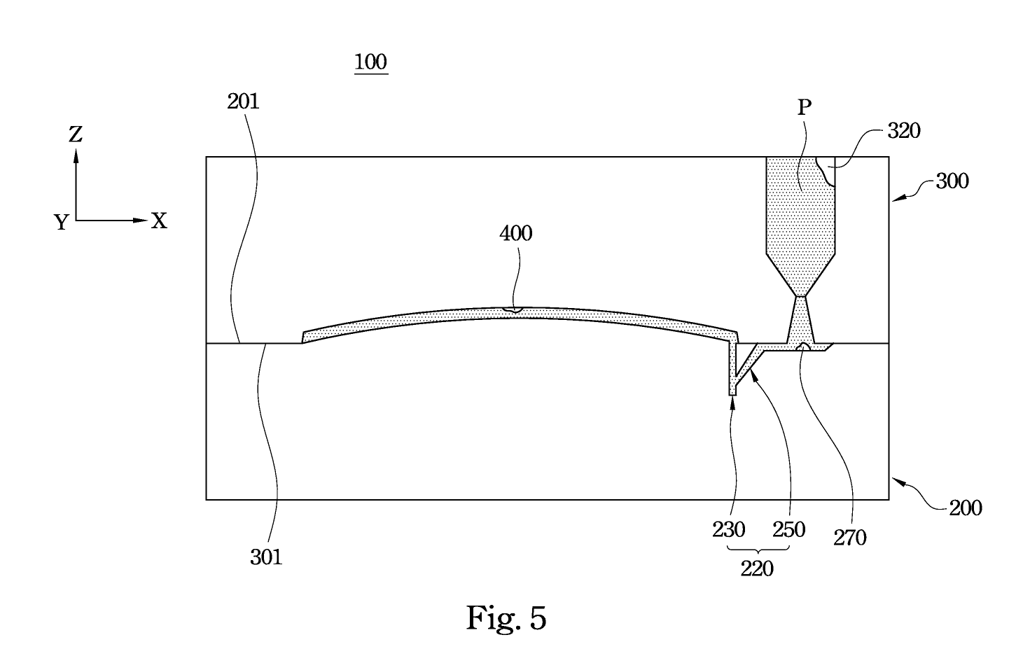

Reference is now made to FIG. 2 and FIG. 4 to FIG. 8. FIG. 4 is a flow chart illustrating a method using a plastic injection molding device according to one embodiment of the present disclosure. It is noted that the method is described below using the plastic injection molding device 100 of FIG. 1. FIG. 5 to FIG. 8 are schematic views illustrating the steps of FIG. 4.

According to the present disclosure, the method of using the plastic injection molding device 100 includes a number of steps, as described in detail below.

In step (401), the male mold 200 and the female mold 300 are engaged with each other as shown in FIG. 2.

In this step, the female mold 300 is moved along the Z-axis direction until it is engaged with male mold 200 as shown in FIG. 2, so that the cavity 400 is defined by the recessed portion 310 of the female mold 300 and the protrusion portion 210 of the male mold 200. The cavity 400 is in communication with the plastic injecting passage 320 through the plastic passing portion 220.

In step (402), a liquid plastic material P is filled into the cavity 400 as shown in FIG. 5.

In this step, referring to FIG. 1 and FIG. 5, the liquid plastic material P is filled into the cavity 400 from the plastic injecting passage 320 via the buffer concave slot 270, the second linear passage 250 and the first linear passage 230 until the cavity 400 is fully filled.

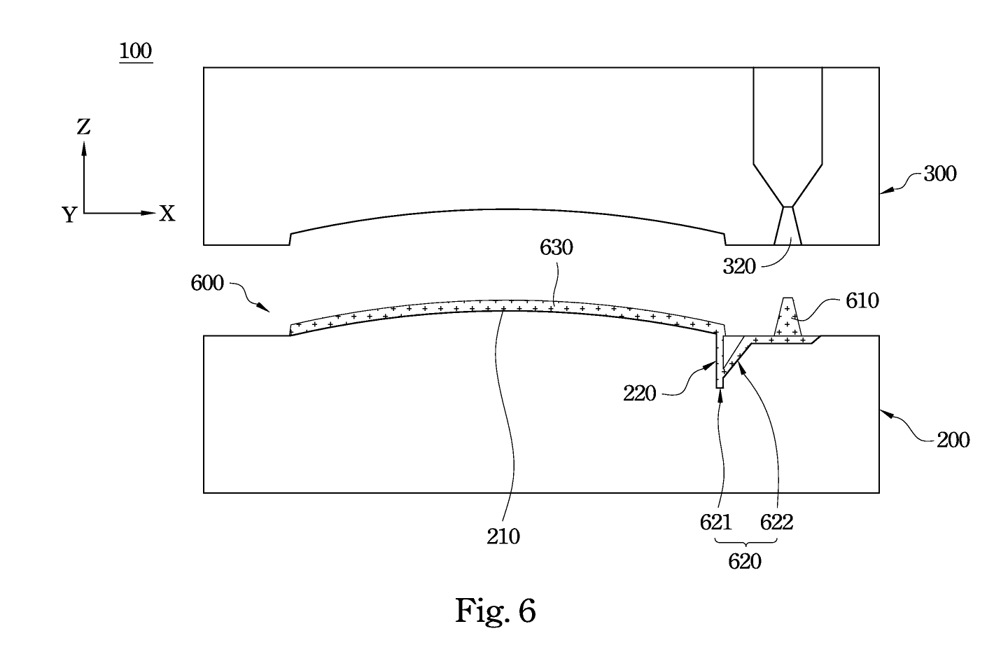

In step (403), the male mold 200 is separated from the female mold 300 as shown in FIG. 6.

Referring to FIG. 5 and FIG. 6, before step (403) is performed, the liquid plastic material P is cooled, and the liquid plastic material P is integrally solidified in the plastic injecting passage 320 to form a first portion 610, in the plastic passing portion 220 to form a second portion 620 and in the cavity 400 to form a third portion 630 so as to form a whole plastic body 600.

In step (403), when the female mold 300 is moved along the Z-axis direction and separated from the male mold 200 such that the plastic injection molding device 100 is in the mold opening state as shown in FIG. 6, the third portion 630 of the plastic body 600 is exposed on a surface of the protrusion portion 210, and the first portion 610 of the plastic body 600 is exposed outside the buffer concave slot 270.

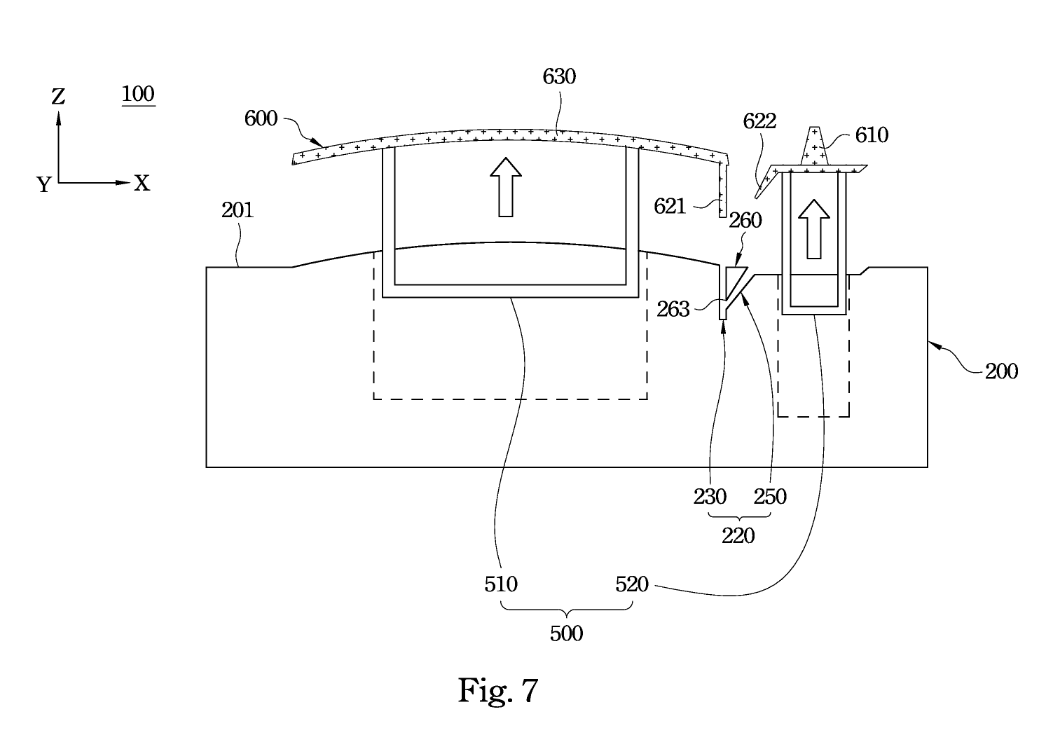

In step (404), the plastic body 600 is ejected from the male mold 200 to thereby cause the part of the plastic body 600 between the first linear passage 230 and the second linear passage 250 to be snapped by the partition portion 260 as shown in FIG. 7.

FIG. 7 is a schematic view illustrating the plastic injection molding device 100 shown in FIG. 1 in an ejecting state. The plastic injection molding device 100 further includes an ejection device 500. The ejection device 500 is formed with a retractable first ejection post 510 and a second ejection post 520. The first ejection post 510 is disposed on the mating surface 201 of the male mold 200 which faces the female mold 300, and corresponds to the location of the cavity 400 for ejecting the part of the plastic body 600 on the surface of the male mold 200. The second ejection post 520 is also disposed on the mating surface 201 of the male mold 200 which faces the female mold 300, but corresponds to the location of the plastic injecting passage 320 for ejecting the other part of the plastic body 600 on the surface of the male mold 200.

In this step, the ejection device 500 is actuated so that each of the first ejection post 510 and the second ejection post 520 of the ejection device 500 can be protruded from the mating surface 201 of the male mold 200 which faces the female mold 300, so as to respectively eject the third portion 630 of the plastic body 600 and the first portion 610 of the plastic body 600 from the male mold 200. Therefore, the two portions 610, 630 of the plastic body 600 can be separated from the mating surface 201 of the male mold 200.

During this process, since the partition portion 260 is disposed between the second linear passage 250 and the first linear passage 230, when the first ejection post 510 and the second ejection post 520 respectively eject the two portions 610, 630 of the plastic body 600, the breaking edge 263 of the partition portion 260 can split the second portion 620 of the plastic body 600. Thus, the part of the plastic body 600 inside the first linear passage 230 (hereinafter referred to as a first segment 621 of the second portion 620) and the part of the plastic body 600 inside the second linear passage 250 (hereinafter referred to as a second segment 622 of the second portion 620) can be physically separated from each other. The first segment 621 of the second portion 620 of the plastic body 600 is connected with the third portion 630 of the plastic body 600, and is separated from the mating surface 201 of the male mold 200 which faces the female mold 300 together with the third portion 630 of the plastic body 600. The second segment 622 of the second portion 620 of the plastic body 600 is connected with the first portion 610 of the plastic body 600, and is separated from the mating surface 201 of the male mold 200 which faces the female mold 300 together with the first portion 610 of the plastic body 600.

In step (405), residual plastic material is removed.

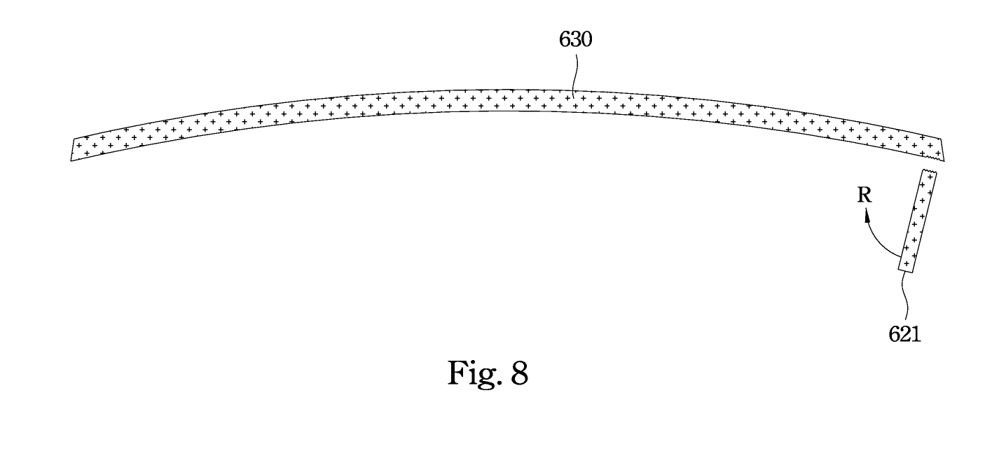

In this step, referring to FIG. 7 and FIG. 8, because portions of the plastic body 600 (i.e., the second segment 622 of the second portion 620 of the plastic body 600 and the first portion 610 of the plastic body 600) have already been removed in step (404), the first segment 621 of the second portion 620 of the plastic body 600 may be easily removed from the third portion 630 of the plastic body 600 (for example, by manually pulling on or rotating the first segment 621 in a direction R). Therefore, a CNC machining of a milling material tip or a tapering angle pin on the male mold or the female mold is not needed, thereby reducing the average cost of post-production and the rejection rate generated during post-production.

In summary, the plastic injection molding device and the method using the same provided by the present disclosure have a number of advantages. In particular, the residual plastic material on the finished plastic product can be split during the mold separating process, thereby making unnecessary CNC machining of a milling material tip or a tapering angle pin on the male mold or the female mold. As a result, the average cost of post-production and the rejection rate generated during post-production can be reduced.

Although the present disclosure has been described with reference to the preferred embodiments thereof, it is apparent to those skilled in the art that a variety of modifications and changes may be made without departing from the scope of the present disclosure which is intended to be defined by the appended claims.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A plastic injection molding device comprising:
a female mold comprising a plastic injecting passage; and
a male mold comprising:
a plastic passing portion having a first linear passage and a second linear passage communicated with each other, wherein the second linear passage is obliquely connected with the first linear passage; and
a partition portion disposed between the first linear passage and the second linear passage,
wherein when the male mold and the female mold are engaged with each other, a cavity is defined between the female mold and the male mold, the first linear passage is in communication with the cavity, and the second linear passage is in communication with the plastic injecting passage,
wherein after a liquid plastic material is filled into the cavity from the plastic injecting passage, the liquid plastic material is integrally solidified to form a whole plastic body in the plastic injecting passage, the plastic passing portion and the cavity,
wherein when the male mold is separated from the female mold, and the plastic body is pushed away from the male mold, the partition portion splits the part of the plastic body in the first linear passage and the part of the plastic body in the second linear passage.

2. The plastic injection molding device according to claim 1, wherein the plastic passing portion is formed in a Y shape, and the second linear passage is obliquely connected between two opposite ends of the first linear passage;
wherein one end of the first linear passage is exposed on a mating surface of the male mold which faces the female mold, and a buffer zone is formed between the other end of the first linear passage and the second linear passage.

3. The plastic injection molding device according to claim 1, wherein the plastic passing portion is formed in a V shape, one end of the first linear passage is exposed on a mating surface of the male mold which faces the female mold, and the other end of the first linear passage is in direct communication with the second linear passage.

4. The plastic injection molding device according to claim 1, wherein the male mold comprises a buffer concave slot on a mating surface of the male mold which faces the female mold, the buffer concave slot is in communication with the second linear passage, an opening size of the buffer concave slot is larger than an opening size of the second linear passage, and when the male mold and the female mold are engaged, the buffer concave slot is in communication with the plastic injecting passage.

5. The plastic injection molding device according to claim 1, further comprising an ejection device, the ejection device comprising:
a first ejection post disposed on the mating surface of the male mold which faces the female mold, and corresponding to the location of the cavity; and
a second ejection post disposed on the mating surface of the male mold which faces the female mold, and corresponding to the location of the plastic injecting passage, wherein the partition portion is disposed between the first ejection post and the second ejection post,
wherein when the male mold and the female mold are separated from each other, the first ejection post and the second ejection post respectively eject the part of the plastic body in the first linear passage and the part of the plastic body in the second linear passage from the mating surface of the male mold which faces the female mold.

6. The plastic injection molding device according to claim 1, wherein the partition portion is formed in a wedge shape, and the partition portion comprises:
a first surface formed on an inner wall of the first linear passage;
a second surface formed angled from the first surface and on an inner wall of the second linear passage; and
a breaking edge formed where ends of the first surface and the second surface meet, the breaking edge being used for splitting the part of the plastic body in the first linear passage and the part of the plastic body in the second linear passage.

7. A method of plastic injection molding using the plastic injection molding device according to claim 1, the method of plastic injection molding comprising:
engaging the male mold and the female mold;
filling a liquid plastic material from the plastic injecting passage, so the liquid plastic material is integrally solidified in the plastic injecting passage, the plastic passing portion and the cavity to form a whole plastic body;
separating the male mold from the female mold; and
ejecting the plastic body from the male mold so as to cause the part of the plastic body between the first linear passage and the second linear passage to be split by the partition portion.

8. The method of plastic injection molding according to claim 7, wherein ejecting the plastic body from the male mold comprises:
protruding a first ejection post and a second ejection post to respectively eject the part of the plastic body in the first linear passage and the part of the plastic body in the second linear passage away from the mating surface of the male mold which faces the female mold.

9. The method of plastic injection molding according to claim 7, wherein a part of the plastic body between the first linear passage and the second linear passage is snapped by a breaking edge of the partition portion.
